(19) United States
(12) Patent Application Publication
(10) Pub. No.: US 2005/0251471 A1
(43) Pub. Date: Nov. 10, 2005

(54) Method for reprocessing accumulator or battery packs

(76) Inventor: Frank Saier, Sonnenbuhl (DE)

Correspondence Address: BACHMAN & LAPOINTE, P.C., 900 CHAPEL STREET, SUITE 1201, NEW HAVEN, CT, 06510, US

(21) Appl. No.: 11/141,797

(22) Filed: May 31, 2005

Related U.S. Application Data
(63) Continuation-in-part of application No. 09/981,582, filed on Oct. 17, 2001.

(51) Int. Cl. G06F 17/60

(52) U.S. Cl. 705/37

(57) ABSTRACT

Method for reprocessing of rechargeable accumulator or battery packs including testing, replacing, tuning, providing individual special types and charging accumulators in a store or in the framework of an independent service by using a special service station. The method includes the provision of service station business partners, the provision of the central office for controlling the overall business procedures, and the provision of a computer-implemented, machine-readable product database. The central office controls the production of the service stations and the supply of the accumulators, batteries, or cells. In addition, the central office also controls the financing of the service stations for the service station business partners. The method includes a complete system for reprocessing accumulator or battery packs.

### CROSS REFERENCE TO RELATED APPLICATION

This application is a continuation-in-part of prior U.S. patent application Ser. No. 09/981,582 filed on Oct. 17, 2001 and claims benefit of priority under 35 U.S.C. §120.

### FIELD OF THE INVENTION

The invention relates to the reprocessing of accumulators or battery packs. It particularly relates to the performance and handling of the service as such, together with the business procedures connected with this.

### BACKGROUND OF THE INVENTION

Accumulators and batteries make the people of today ever more mobile. Telephoning on the road, working on the train or airplane on a laptop, but also screwing and drilling when no wall outlet is nearby. These are all taken for granted in our everyday life. Ever more devices are independent from a fixed power supply system and from cumbersome cables and get their energy from small, compact stores. Batteries must be replaced, accumulators must be recharged and serviced, and possibly replaced. There are just as many accumulators and batteries on the market as there are devices, but it is not always easy to obtain the appropriate energy store. Long trips and waiting times are annoying and, particularly with older devices which are no longer produced, it becomes difficult. In this case, under some circumstances, a relatively large amount money has to be paid for a new accumulator pack or battery pack after a short time. Many manufacturers cannot provide a replacement at all after a short time, so that the device can no longer be used.

Therefore, there is a need to renew run-down accumulators or batteries in an existing accumulator pack. In addition, individual and special types of accumulator or battery packs may be in demand according to the desires of the consumer.

The present invention therefore has as its object the offering of a corresponding service which allows the reprocessing of any desired type of accumulator or battery pack. This is achieved by the invention described in the following.

### BRIEF DESCRIPTION OF THE INVENTION

According to the invention, a method for reprocessing rechargeable accumulator or battery packs, including checking, replacing, tuning, providing individual special types and charging accumulators in a store in the framework of an independent service by using a special service station is described. The special service station is known and essentially comprises a special welding device for connecting the accumulators and/or batteries.

According to the method, multiple service station business partners, who are able to offer these services after establishment, are provided. These services can be performed in a shop or as an independent service provider, for example in the framework of a service technician service for the maintenance of technical facilities, for example in a hospital. Furthermore, a central office is provided for supplying the service station business partners with the necessary equipment and for controlling the service process for the service station business partners; a product database is provided with all data about accumulator or battery driven devices, including the manufacturer, technical data, the types of accumulator and/or battery packs or individual cells used and their technical data and prices, with the product database being supplied by the central office with appropriate data. The central office receives these data from the service station business partners, among other sources. Furthermore, the service station business partners receive access to the product database. The central office controls the production of the service stations, which are needed by new service station business partners, and the supply of accumulators or batteries at the request of the service station business partners through the central office. This method thus allows an optimum supply of the market with the parts necessary for repair through the service station business partners. According to a further implementation, financing can also occur in such a way that a finance office for financing of service stations, which are purchased by the service station business partners from the central office, is provided, with the central office supplying the finance office with the necessary data concerning the service station business partners.

According to a further advantageous implementation of the method, it includes controlling the reprocessing of service stations which are given back to the finance office by service station business partners who give up their business. Through this measure, it is not always necessary to obtain new batteries or accumulators, rather batteries and/or accumulators may be taken back from the market can be overhauled, reprocessed and returned in a like-new condition to the customer(s).

### BRIEF DESCRIPTION OF THE DRAWING

FIG. 1 is a schematic block diagram of the method of the present invention;

FIG. 2 is a side view of a welding device for use in the method of the present invention;

FIG. 3 is a front view of the welding device of FIG. 2 with the safety cover removed;

FIG. 4 is a side view of the telescoping electrode of the welding device of FIG. 2;

FIG. 5 is a schematic representation of the relays and resistance for the welding device of FIG. 2;

FIG. 6a is a front view of a welding station equipped with the welding device of FIG. 2; and

FIG. 6b is a side of the welding station of FIG. 6a.

Like reference numbers and designations in the various drawings indicate like elements.

### EXACT DESCRIPTION OF THE INVENTION

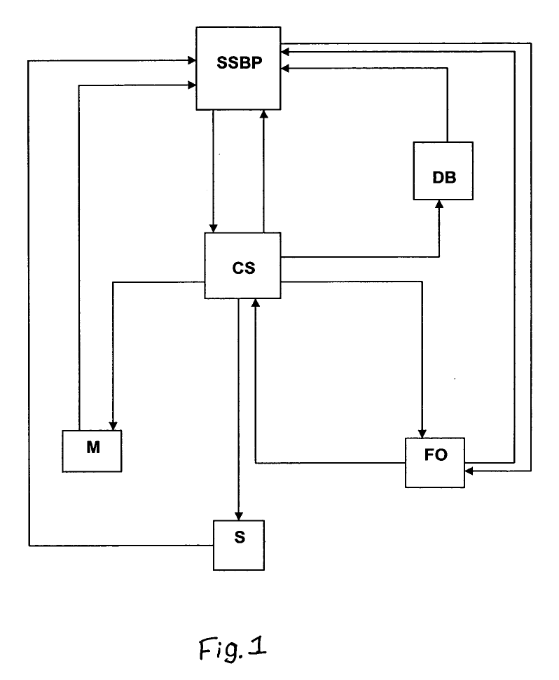

The central office CS controls all business procedures and allocates the service station business partners SSBP the right to use the trademarks under which the services are to be offered to the customers by the service station business partners SSBP. The service station business partners SSBP purchase the devices and facilities necessary for performing services at the central office CS, particularly the welding device for connecting the individual cells. By order of the service station business partners SSBP, the central office CS arranges for the production of the welding station necessary for performing the services and the other facilities as well as their supply to the service station business partners SSBP. This is illustrated in FIG. 1 in such a way that the producer M supplies directly; however, supply can also occur via the central office CS. The same is true in regard to the necessary accumulators or batteries. These are also ordered by the service station business partners at the central office CS, which in turn effects the supply of the desired parts via a supplier S, so that the desired parts arrive at the service station business partners SSBP within 24 hours.

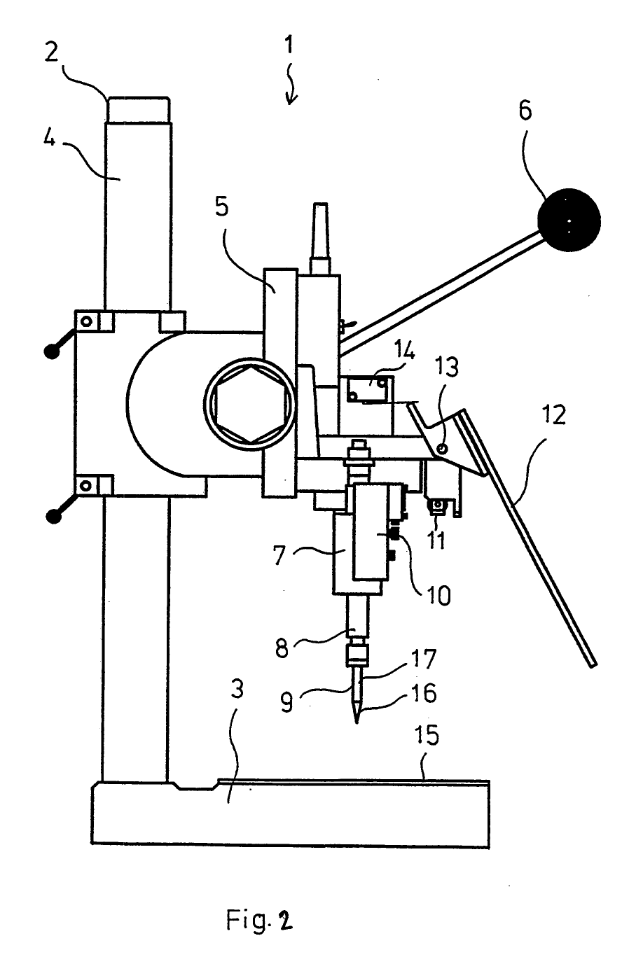

The aforementioned welding station may comprise a welding device described in German Patent Publication No. 29601662U1 entitled “Spot Welding Apparatus”, published on May 30, 1996, and German Patent Publication No. DE 19702286B4, entitled “Spot Welding Apparatus”, published on May 19, 2005. Referring now to FIGS. 2-6, a welding device 1 comprises a stand 2 with a foot 3 and a carrying cross-beam 4. Stand 2 may comprise any stand known in the art such as a drill press stand. At stand 2, a mounting plate 5 may be movable in a vertical direction using a hand lever 6, which can be locked in its respective position at carrying cross-beam 4. A welding mount 7 is attached to mounting plate 5. Welding mount 7 comprises two welding electrodes 8 mounted perpendicularly in a downward direction. Each welding electrode 8 comprises an electrode point 9 having a substantially telescopic shape and capable of moving up and down in an axial direction. A push button switch 10 is designed to adjust the contact pressure of each welding electrode 8 relative to a battery or accumulator. A light source 11 provides an amount of lighting sufficient to illuminate an area around electrode points 9 to view the contact point with the battery or accumulator. A safety visor 12 is adjustably mounted to a horizontal axle 13, which acts a hinge, to permit an operator to adjust visor 12 relative to the operator and the welding electrodes 8 and provides for the operator's safety and a clear view of the welding point contact. Welding device 1 may be operated once safety visor 12 is closed downward and a power switch 14 is turned on. In addition, an isolation disk 15 is disposed atop foot 3 of stand 2 for safety. Welding device may operate at a current that is dependent upon the application as will be recognized and understood by one of ordinary skill in the art. For example, welding device 1 may use a current in the range of approximately 30 amperes to 2500 amperes, and preferably a current of approximately 1200 amperes.

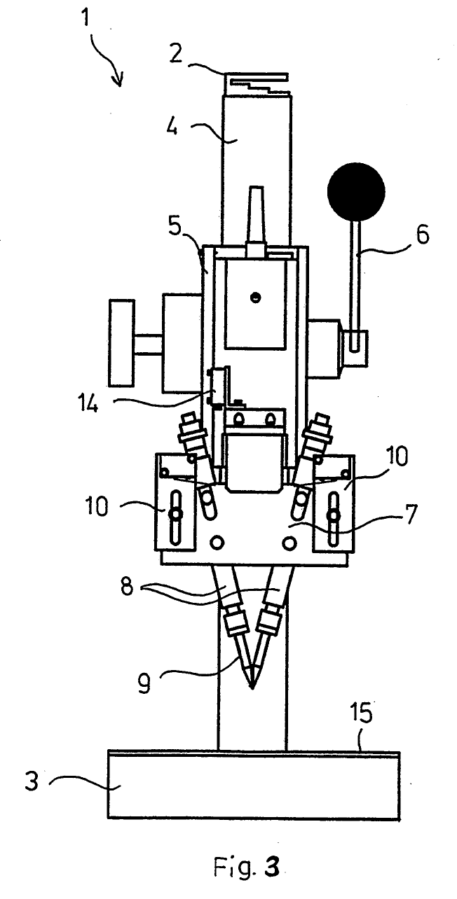

FIG. 3 illsutrates a front view of the welding device 1. Safety visor 12 is omitted in order to illustrate the V-shaped mounting of electrodes 8 to welding mount 7 of welding device 1. As shown, the points of the two electrodes 8 may make contact with one another. However, each electrode 8 may be moved in an axial direction which translates into a telescoping diagonal motion by each electrode 8 such that the electrodes 8 no longer make contact with each other but may be maintained within a certain distance between each other and moved a distance sufficient enough to make contact with a battery or accumulator and perform the welding operation. The distance between electrodes 8 is preferably maintained as small as possible. For example, a distance of approximately 0.01 millimeters between electrodes 8 can be achieved by this arrangement. Each electrode point 9 comprises a cylindrical body 17 which extends to form a point having a tapered exterior surface 16 and a chamfered interior surface 18. Chamfered interior surface 18 comprises a flat surface in order to realize as small an electrode gap as possible between electrodes 8, as the chamfered sides of electrodes 8 are positioned opposite one another. Each electrode 8 may be comprised of any electrically conductive material, and preferably comprises copper. Each electrode point 9 may comprise a length of approximately 2 millimeters to 80 millimeters.

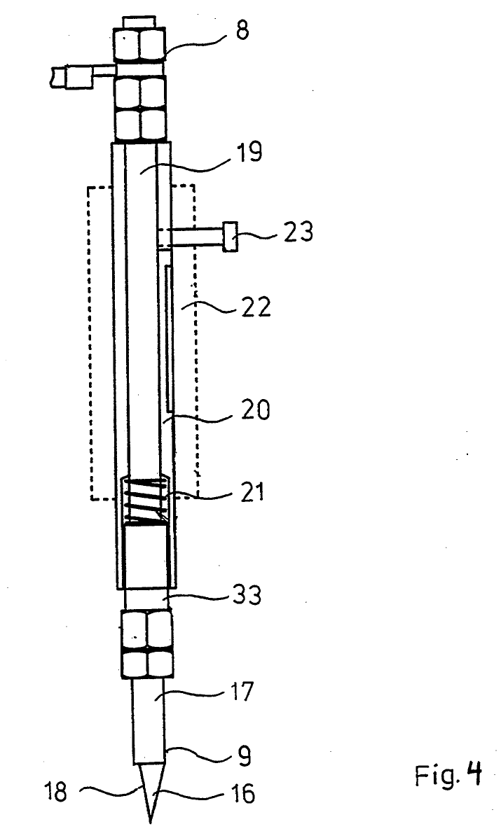

Each electrode 8 and electrode point 9 is retractable and may be affixed within an electrode carrier 19 of welding device 1. Electrode carrier 19 is fitted with a spring 21 and concentrically disposed within a guide sleeve 20. An electrode structure 22 may house electrode carrier 19, guide sleeve 20 and spring 21 Both electrode structure 22 and guide sleeve 20 may comprise a plastic material capable of withstanding the operating temperatures of welding device 1, and preferably withstand continuous exposure to operating temperatures of up to approximately 80° C. (176° F.). Suitable plastic materials include, but are not limited to, polyacetal copolymers, combinations thereof and the like. The diameter of each electrode point 9 may be equivalent to or less than the diameter of cylindrical body 17 as well as the diameter of electrode carrier 19. Preferably, the diameter of each electrode point 9 is approximately 1.5 millimeters to 25 millimeters. When electrode point 9 makes contact with a battery or accumulator, spring 21 compresses within guide sleeve 20 and electrode 8 becomes displaced an amount of distance 33 as shown in FIG. 4. An additional push button switch pin 23, which moves in a radial direction against electrode carrier 19, provides a friction adjustable means in combination with a displacement distance 33 of spring 21 to adjust the contact pressure of electrode point 9 to a battery or accumulator in advance for the release of the welding procedure. The amount of time electrodes 8 remain in contact with a battery or accumulator is dependent upon the welding application as will be recognized and understood by one of ordinary skill in the art. Generally, the amount of time electrodes 8 remain in contact with a battery or accumulator is an amount sufficient to effectively weld the batteries or accumulators together and in place without causing any damage to the batteries or accumulators. Preferably, the amount of time is sufficient to effectively weld a metal band disposed about one or more batteries or accumulators without causing any damage to the batteries or accumulators. The amount of time may be about 1 millisecond to 1 second, and preferably about 20 milliseconds to 30 milliseconds. The amount of pressure exerted by electrodes 8 upon a battery or accumulator is an amount sufficient to achieve an acceptable weld without causing damage to the battery or accumulator. The one or more batteries or accumulators banded together may then be disposed within and connected to a housing within a product requiring the use of said batteries or accumulators.

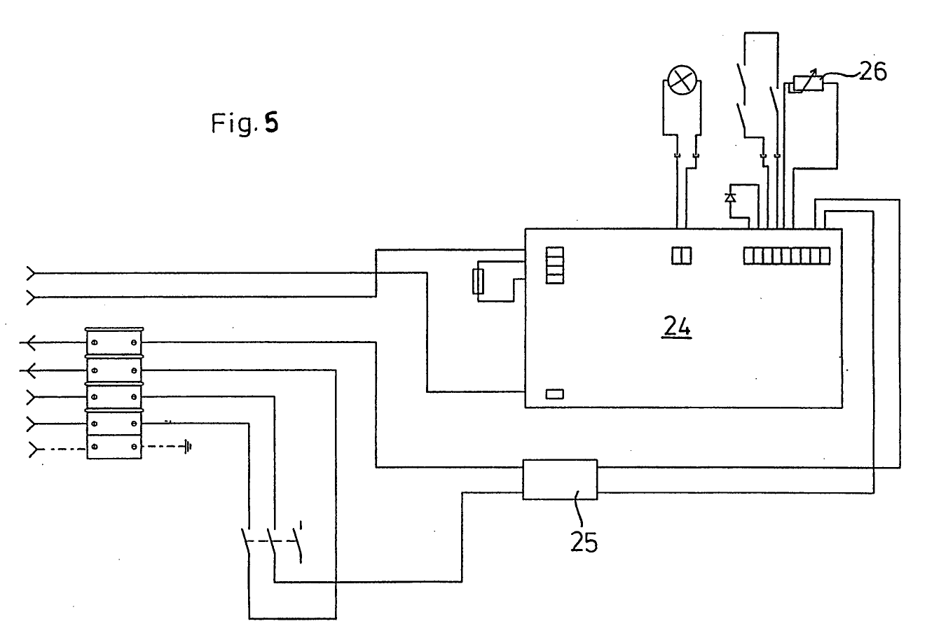

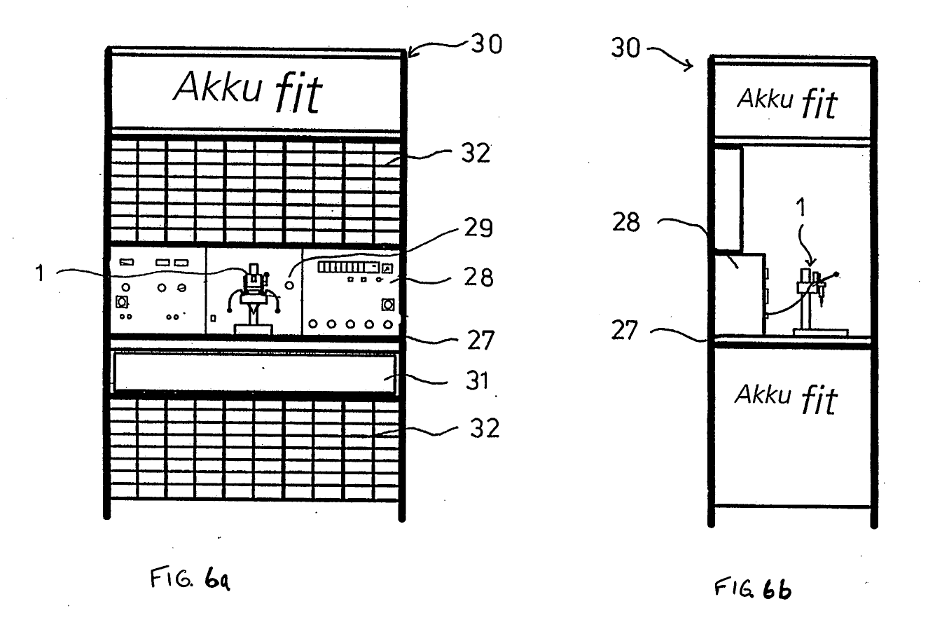

Referring specifically now to FIGS. 5, 6a and 6b, FIG. 5 is a representative schematic diagram of an open loop timing system of the welding station. When an acceptable pressure is achieved by the placement of electrodes 8 upon one or more batteries or accumulators, a special relay 25 may be activated to provide a sufficient welding current over a resistance 26 for an amount of time sufficient to achieve an acceptable weld. FIGS. 6a and 6b depict a representative illustration of the welding station 30 for use in the present method. Welding device 1 may be disposd upon a sill plate 27 and in front of a control panel 28. The control panel 28 may comprise controls, indicating instruments, access featureses and the like, necessary to operate the welding station. A rotary button 29 may serve to allow the operator to control the amount of welding time for a given application. In welding station 30 control panel 28 may also include the welding transformer (not shown), the welding control (not shown), the Accumulator fast tester (not shown) and an additional battery charger (not shown). Work station 30 may also include an additional tool drawer 31 underneath sill plate 27 as well as modular compartments 32 capable of accepting different individual boxes, drawers, and the like, so that individual elements can be easily changed, replaced and modified.

A database DB is provided by the central CS which contains all of the information about the data of battery-operated devices and their producers, the technical data, the types of accumulators and and/or battery packs or individual cells used, and their technical data and prices. The service station business partners have access to this. The database DB is kept current by the central office CS, with the service station business partners also being required to inform the central office CS of newly appearing devices and/or the accumulators or batteries required for them, in order that this new information can enter the database DB. Database DB may comprise a computer-implemented, machine readable database accessible by one or more parties described herein, and preferably all of the parties described herein. The computer-implemented, machine readable database DB may be stored on an intranet which is the inhouse computer network of the central office CS, e.g., a computer (stationary or mobile), a server of the intranet, a machine readable storage medium capable of storing, permit retrieval of and alteration to the DB contents, and the like. The computer-implemented, machine readable database DB may be accessible to all the parties described herein via the internet, the intranet of the central office CS, a wireless application protocol or another moble telecommunication unit, a network for mobile telecommunication (GSM) via a cellular area or satellite system, and the like, using a computer at their own service station, a mobile computer (e.g., a laptop computer), a personal digital assistant (PDA) equipped with Bluetooth® technology, and the like, by the service station business partners. In addition, the service station business partners SSBP may use the internet, for example, electronic mail, instant messaging service, JAVA® applet, and the like, to provide new information as described above to the central office CS or even update the computer-implemented, machine readable database DB themselves using a secure connection via the internet as is understood by one of ordinary skill in the art.

The system thus allows the reprocessing of rundown accumulator and battery packs by specialists who are easy to train and who do not require any separate previous professional qualifications. The accumulators and batteries can be relatively rapidly checked and made ready for use again. The production of individual special accumulator packs or the increase of the accumulator capacity is thus also not a problem.

If the service station business partner is not in a position to procure the financial means for the purchase of the facility, there is the possibility that he can receive the necessary financial means through a finance office FO, which receives the data for this transaction from the central office CS. If a service station business partner, who has received the financial means via the finance office FO, no longer wishes to offer the service and wants to give back the welding device and the facility, the finance office FO notifies the central office of this, which causes the welding device and the facility to be taken back and processed, so that a new facility can be produced from the device and the facility which were given back.

This entire business idea thus provides a system with which the customers can be optimally supplied with reprocessed accumulator packs or battery packs.

1. A method for reprocessing chargeable accumulators or battery packs, said method comprising
providing a plurality of service station business partners, said partners being capable of offering the services of reprocessing chargeable accumulators and battery packs selected from the group consisting of checking, replacing, tuning, and providing individual charging accumulators in a store or in the framework of an independent service by using a special service-station;
providing a central service office for supplying said service station business partner with the necessary equipment, wherein said central service office controls the service process of said service station business partners;
providing a computer-implemented, machine-readable product database comprising a data selected from the group consisting of battery power devices, producer, technical data, kinds of accumulators or battery packs or single cells, technical data, and prices, wherein said computer-implemented, machine-readable product data base is supplied with the respective data by the central service office and said data at least in part being received from the service station business partners; and
providing access of said service station business partners to said computer-implemented, machine-readable product database;
providing at least one producer of welding stations;
providing at least one supplier for accumulators or batteries;
wherein said central service office arranges the delivery of a welding station either directly by the producer of the welding station or by the central station, and
wherein said central service office arranges on demand of the service station business partners the delivery of the required parts which are necessary for the service station business partners to perform said services.

2. The method according claim 1 further comprising
providing a financial office for financing the service station, being purchased by the service station business partner at the central service office; said financial office receiving the necessary data concerning the service station business partner from the central service office.

3. The method according claim 2 further comprising
controlling the processing of service stations that are given back to said financial office by service station business partners.

4. The method according claim 3 further comprising
causing of retraction of said service station and producing a new facility from said service station given back by said manufacturer.
